(19) United States
(12) Patent Application Publication
(10) Pub. No.: US 2006/0149175 A1
(43) Pub. Date: Jul. 6, 2006

(54) Apparatus for applying traction

(76) Inventor: Paul Smith, London (GB)

Correspondence Address: GABLE & GOTWALS, 100 WEST FIFTH STREET, 10TH FLOOR, TULSA, OK, 74103, US

(21) Appl. No.: 10/545,561

(22) PCT Filed: Feb. 16, 2004
(86) PCT No.: PCT/GB04/00572

§ 371 Date: Aug. 12, 2005

(30) Foreign Application Priority Data
Feb. 14, 2003 (GB) 0303466.7
May 14, 2003 (GB) 0311099.6

(51) Int. Cl. A61H 1/02

(52) U.S. Cl. 601/148; 601/23; 601/24

(57) ABSTRACT

The present invention relates to (with reference to FIG. 1) apparatus (1) for applying traction to a human body. The apparatus (1) comprises a first body support (2) for supporting a user's upper back and a head rest (3) located on top of the upper surface (7) of the first body support (2) and slidable along the upper surface (7). The apparatus has means for causing the head rest to slide along the upper surface (7) of the first body support. The sliding of the head rest (3) along the upper surface (7) to move the supported head from the torso and thereby applies traction to the human body. Additionally or alternatively a pair of shoulder rests (4) can be provided which when slid across the upper surface (7) provide traction across a user's shoulders. Preferably, the body support (2), the head rest (3) and the shoulder rests (4) all comprise inflatable bladders and the traction is applied to the user's body by inflating the bladders.

The present invention relates to an apparatus for applying traction to a human body. In particular, it relates to an apparatus for enabling a user to apply gradual traction to the neck and/or the back and/or the shoulders to induce a reduction of physical tension and to simulate CV-4 relaxation techniques.

Air cushions used to aid relaxation are known in the art. For example, U.S. Pat. No. 4,984,315 discloses a pillow having a polyfill body and containing an inflatable bladder at one end. The bladder may be inflated to adjust the size and shape of the pillow to provide support for a pregnant woman. This device does not provide for any traction to encourage and stimulate relaxation.

The present invention provides in a first aspect apparatus for applying traction to a human body comprising:

a first body support for supporting a first part of the human body, the first body support having an upper surface engageable by the first part of the human body;

a second body support for supporting a second part of the human body located on top of the upper surface of the first body support and slidable along the upper surface; and

means for causing the second body support to slide along the upper surface of the first body support; wherein

sliding of the second body support along the upper surface of the first body support acts to move the second part of the human body away from the first part of the human body and thereby applies traction to the human body.

The present invention provides in a second aspect apparatus for applying traction to a human body comprising:

a body support for supporting an upper back of a human user, the first body support having an upper surface engageable by the upper back of the human user;

a head rest located on top of the upper surface of the body support and slidable along the upper surface;

a pair of shoulder rests each located on top of the upper surface of the body support and each slidable along the upper surface;

means for causing the head rest to slide along the upper surface of the first body support to apply traction to a neck of the user; and

means for causing the shoulder rests to slide along the upper surface of the first body support away from each other to apply traction across shoulders of the user.

Thus, the apparatus provides stimulation and relaxation to a user.

Preferred embodiments of the present invention will now be described, by way of example only, with reference to the accompanying figures, in which:

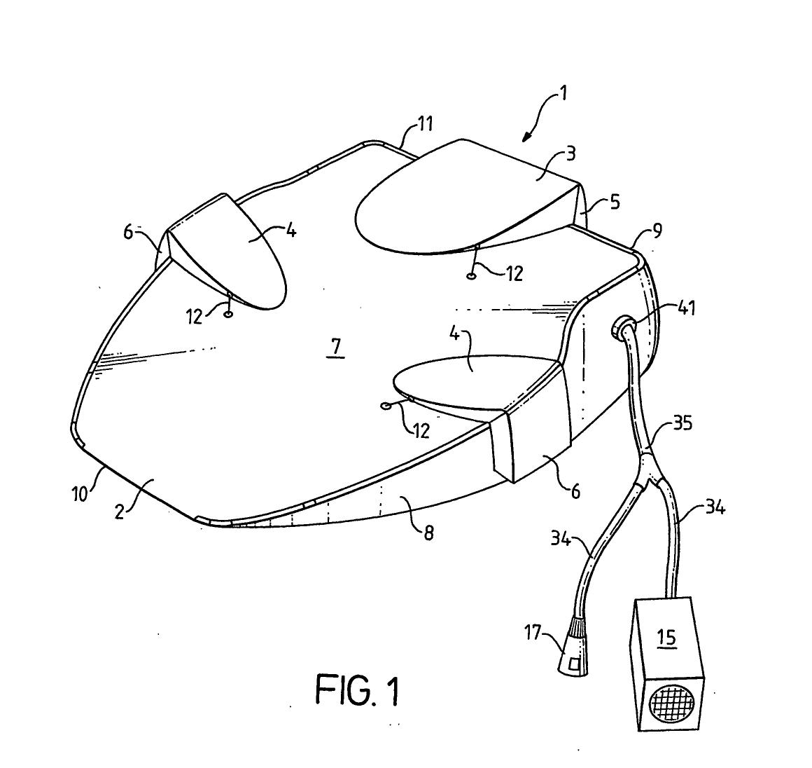

FIG. 1 is a perspective view of a first embodiment of apparatus according to the present invention;

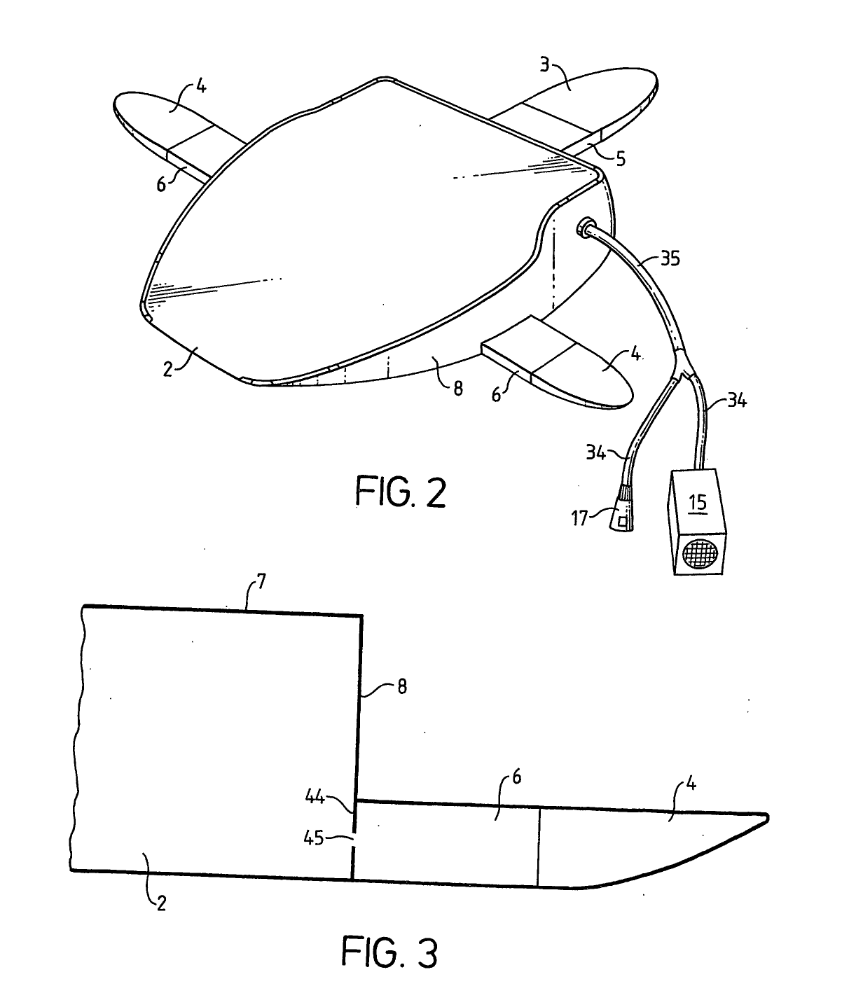

FIG. 2 is a perspective view of the apparatus of FIG. 1;

FIG. 3 is a cross-section through a part of the apparatus of FIGS. 1 and 2;

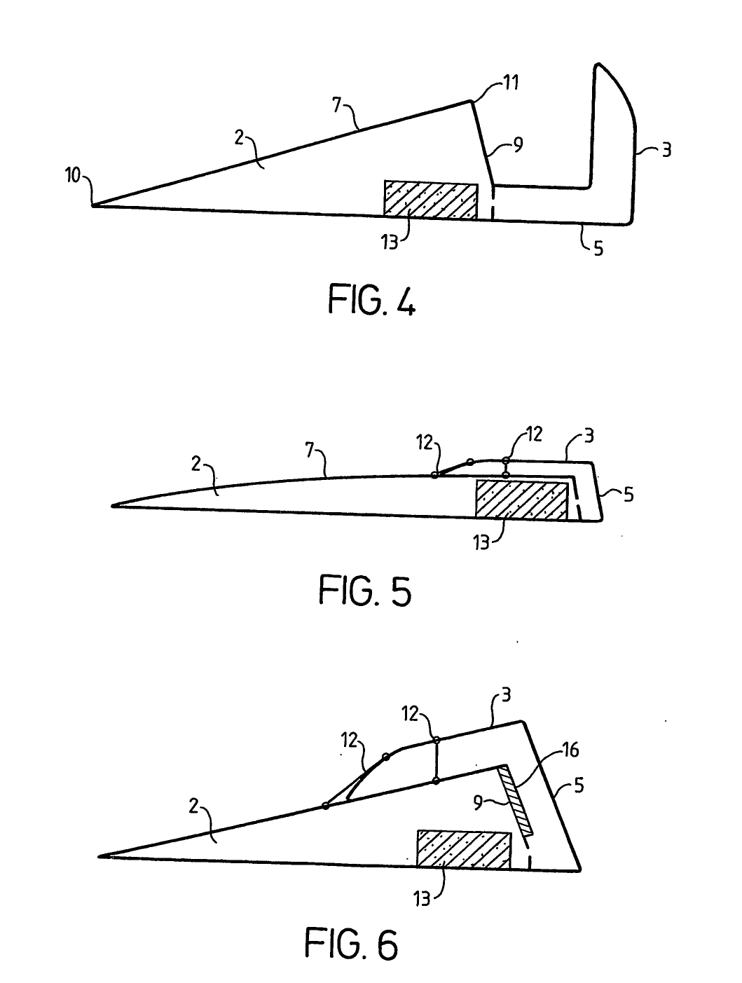

FIG. 4 is a cross-section through a first variant of the apparatus of FIGS. 1 to 3, showing a head rest in a partially unfolded condition;

FIG. 5 is a cross-section through the variant of FIG. 4 showing the variant in a partially deflated condition with a folded headrest;

FIG. 6 is a cross-section through a second variant of the apparatus of FIGS. 1 to 3;

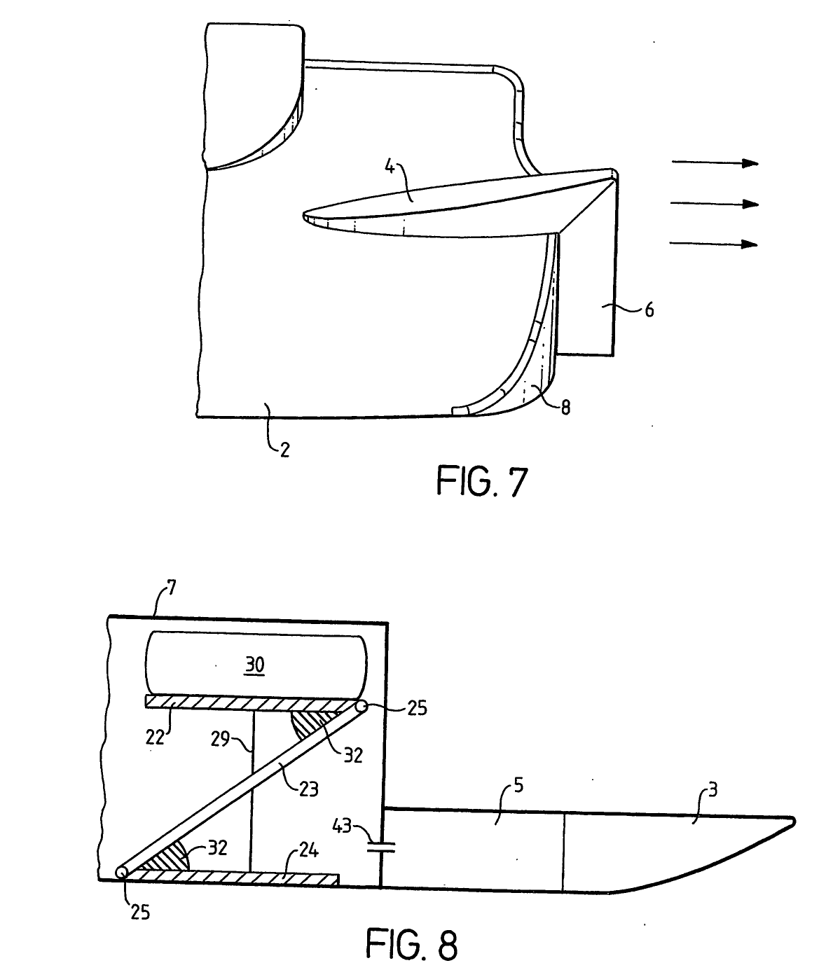

FIG. 7 is a elevation view of a part of the apparatus of FIGS. 1 to 3 showing a shoulder rest;

FIG. 8 is a first cross-section view of part of apparatus of a second embodiment of the present invention, with a head rest in an unfolded condition;

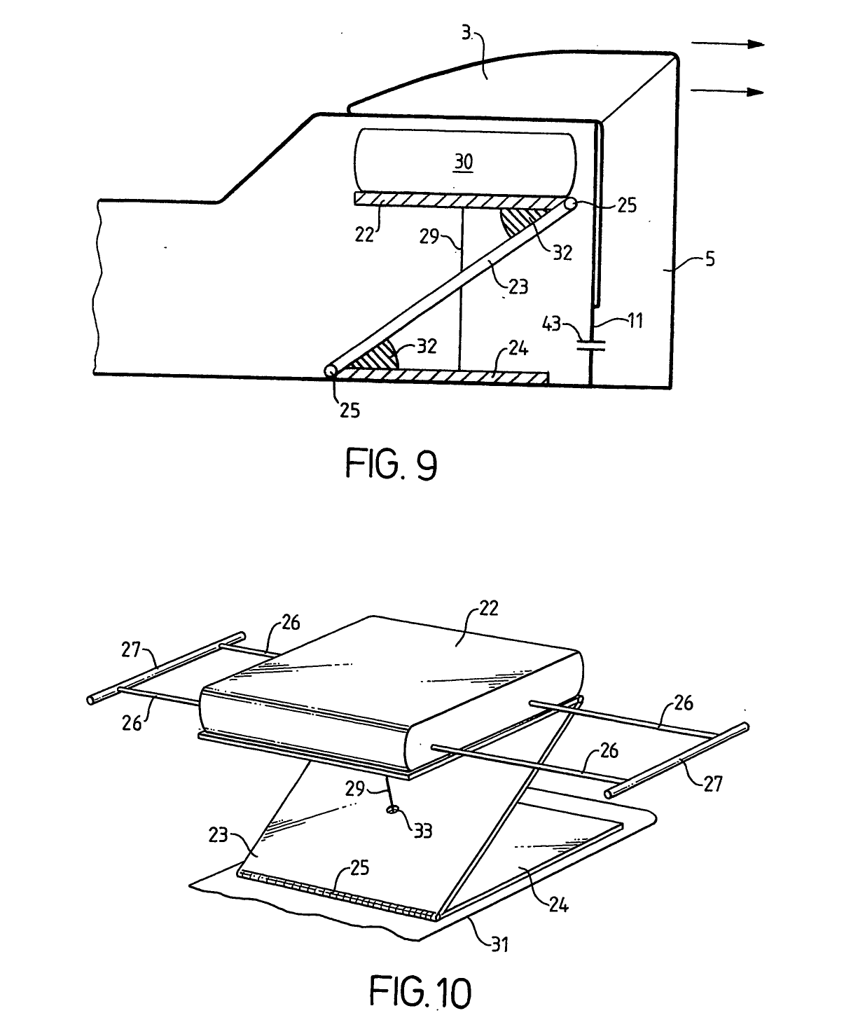

FIG. 9 is a second cross-section view of the part of the FIG. 8 apparatus shown in the figure, with the head rest in a folded condition;

FIG. 10 is a perspective view of a folding frame of the apparatus of FIGS. 8 and 9;

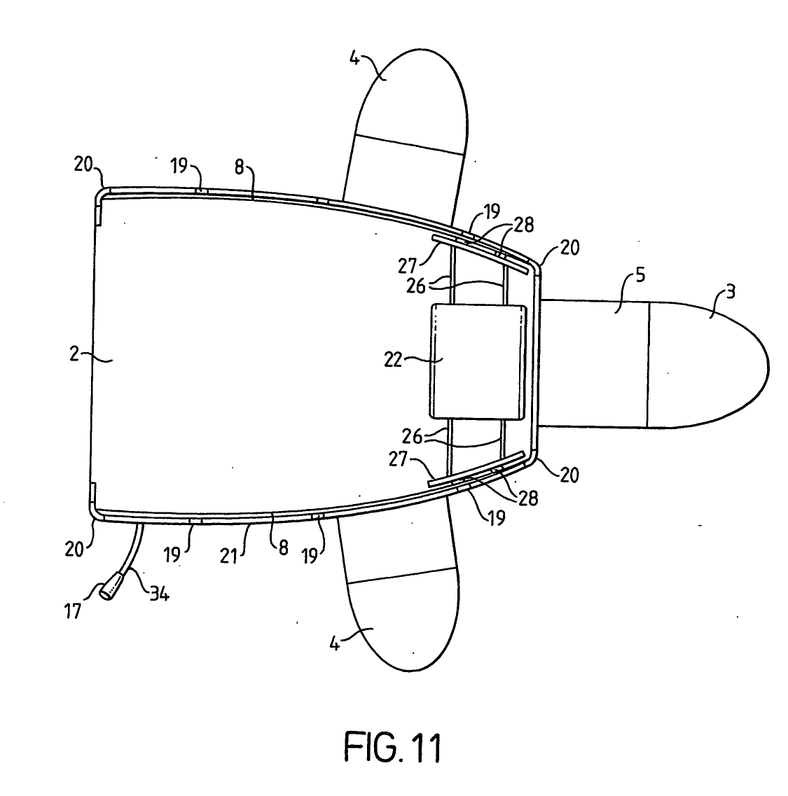

FIG. 11 is a plan view of the apparatus of FIGS. 8 to 10;

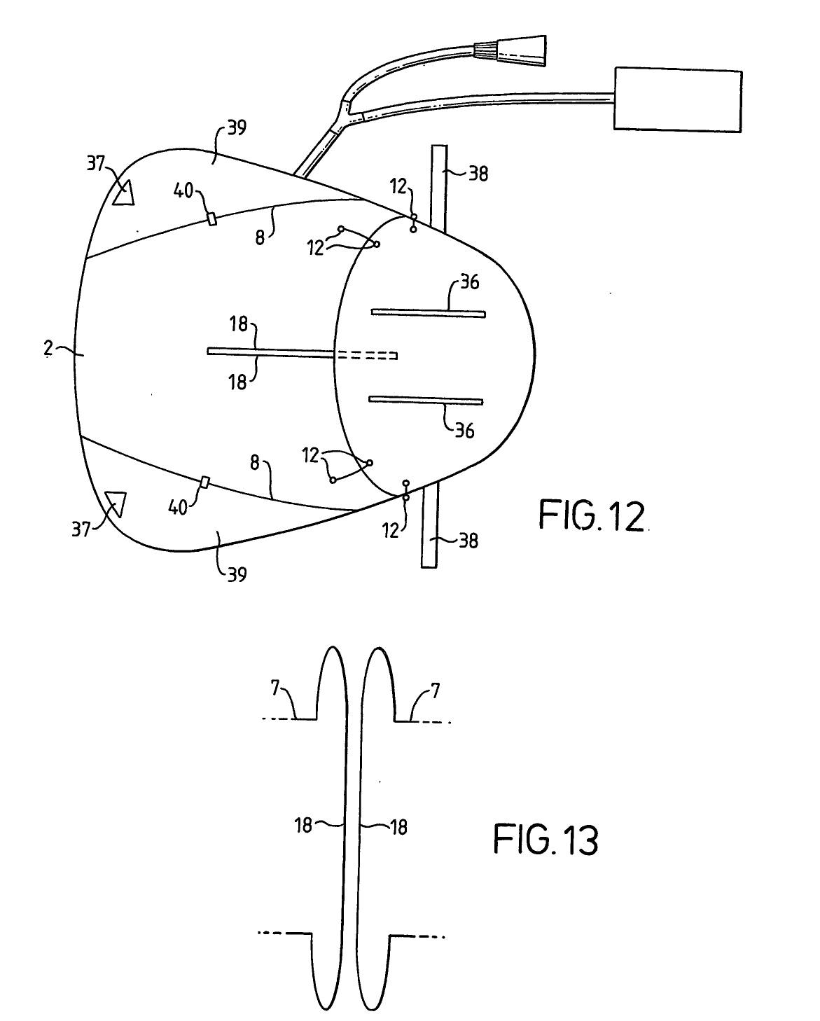

FIG. 12 is a plan view of the apparatus according to a third embodiment of the invention; and

FIG. 13 is a view of a part of the apparatus of FIG. 12.

As shown in FIGS. 1 and 2, the apparatus 1 comprises a first body support 2, a second body support in the form of a head rest 3 and third and fourth body supports in the form of two shoulder rests 4. The first body support 2, head rest 3 and two shoulder rests 4 are formed as bladders inflatable and deflatable to provide relaxation and stress relief to a person lying on the apparatus 1.

The body support 2 is an air bladder substantially shaped as a triangular prism, or wedge shape, when inflated. The body support 2 tapers to a lower end 10, and has an upper end 11 which defines the maximum height of the body support 2. The body support 2 has an upper surface 7, supported by side walls 8 and top wall 9.

As shown in FIG. 1, the head rest 3 is an air bladder fluidly connected with the body support 2. It is located equidistant between side walls 8 of the body support 2 and adjacent to a side wall 11 of the body support 2. The head rest 3 lies over the upper surface 7 of the body support 2. The head rest 3 effectively forms a pillow to support the head of a user in a comfortable position.

The head rest 3 is provided a distal end of an arm 5 which is connected to the body support 2. The arm 5 is connected to the body support 2 at the base of side wall 9. The point of connection is spaced from upper surface 7. The arm is of a flexible material and is folded about the side wall 9 so that its distal end overlies the upper surface 7 and provides the head rest 3

As shown in FIG. 1, the shoulder rests 4 are also arms formed from air bladders fluidly connected to the body support 2. The two shoulder rests 4 are located approximately half-way between the lower end 10 and the upper end 11 of the body support 2 and can be folded to lie over the upper surface 7 of the body support 2 (see FIG. 1). One shoulder rest 4 is associated with one side wall 8 of the body support 2 and one shoulder rest 4 is associated with the other side wall 8. The two shoulder rests 4 are thus spaced apart by a suitable distance such that each shoulder rest 4 contacts a shoulder of a user lying on the air cushion 1.

Each of the shoulder rests 4 are provided by the distal ends of arms 6. The arms 6 are connected to the body support 2 at the bottom of the side walls 8, approximately half-way between the upper end 11 and lower end 10 of the body support 2. The points of connection are spaced from the upper surface 7. The arms 6 are in fluid connection with the body rest 2 to allow air flow between the shoulder rests 4 and the body support 2. FIG. 7 shows a shoulder rest 4 and the body support 2 supporting a user.

Since the head rest 3 and shoulder rests 4 are flexibly connected to the body support 2, they can easily move relative to the body support 2. This movement is an integral part of the functioning of the apparatus. However it is preferable to limit the amount and/or direction of movement. This is achieved by straps 12 (see FIG. 1). The straps 12 connect the upper surface 7 of the body support 2 to the underside of the head rest 3. Straps 12 also connect the upper surface 7 of the body support 2 to the undersides of the two shoulder rests 4. Preferably, the head rest 3 and shoulder rests 4 have straps 12 attached at two discrete regions. One set of straps 12 are attached adjacent to the distal ends of the head rests 3 and shoulder rests 4. A second set of straps 12 are attached approximately half-way between the distal ends of the arms and the side walls of the body support 2.

The straps 12 limit the distance which the head rest 3 and shoulder rests 4 may move from the upper surface 7 of the body support 2. However, the straps 12 do not substantially limit movement of the head rest 3 and shoulder rests 4 in the plane of the upper surface 7 of the body support 2. The straps 12 instead force the head rest 3 and shoulder rests 4 to slide along parallel to the upper surface 7 of the body support 2, and prevent movement perpendicularly to the upper surface 7. The straps 12 may be elastic, non-elastic or a combination of elastic and non-elastic. The straps 12 may be used to cause the head rest 3 to adopt on inflation a concave shape in the upper surface of the head rest 3, in order to cradle the user's head. The straps 12 can also be used to limit the movement of the head rest 3 and shoulder rests 4 in a direction parallel to the upper surface 7 to limit traction applied to a user.

The straps 12 also prevent the head rest 3 from covering a user's ears when the head rest 3 is inflated. The covering of the user's ears results in a partial loss of the sense of hearing, and this sensory deprivation may cause uneasiness and prevent relaxation.

As shown in FIG. 1, a sidewall 8 of the body support 2 is provided with a valve 41. The valve 41 allows connection of the air bladder of body support 2 with an air pump 15. The air pump 15 is powered by an electric motor and pumps air into the body support 2 through flexible tubing 34, 35 at a rate which may be controlled by the user. The pump 15 may also be used to deflate the bladders at a required rate.

The air pump 15 is preferably controlled by a handset 17, which is electrically connected to the air pump 15. The handset 17 may control one or more functions of the air pump 15 such as switching the air pump 15 on and off, controlling the direction of the flow of air, i.e. whether the bladders are being inflated or deflated, or controlling the rate of flow of air. The handset 17 may also comprise a timer and alarm, such that an audible alarm sound is generated after a predetermined time period. The handset 17 may also comprise an inflate/deflate repeat function. In this function the handset 17 would instruct the air pump 15 to inflate the bladders and then deflate the air bladders 1 and then repeat this cycle periodically.

Since the handset 17 is located remotely from the air pump 15, the user has flexibility about the location of the air pump 15 whilst holding the handset 17. In the illustrated embodiment, the tubing 34 extends from the air pump 15 to a T-connector 35. A length of tubing 34 connects the T-connector 35 to the valve 41, and a length of tubing 34 connects the T-connector 35 to the handset 17. This allows the handset 17 to control the rate of flow of air entering the valve 14. The electrical wires connecting the handset 17 to the air pump 15 may be routed through the tubing 34 and T-connector 35.

In use, the apparatus 1 may be placed on a flat horizontal surface such as a floor or bed. The user lies on the air cushion 1 in a supine or reclining position so that his/her upper back is supported by the body support 2. The user's head is located on the head rest 3 and the user's shoulders are located one each on the shoulder rest 4. The pump 15 is switched on with the handset 17 and begins to inflate the air bladders. The body support 2, head rest 3 and shoulder rests 4 all gradually fill with air. The air passing form the bladder of the body rest 2 to the bladders of the head rest 3 and the shoulder rests 4 is forced to pass through restrictive orifices e.g. 45 (see FIG. 3). This means that the body rest 2 is inflated in preference to the head rest 3 and the shoulder rests 4, which inflate more slowly.

As the body support 2 and arm 5 inflate they expand. The arm 5 presses against the side wall 9 and expands away from the wall 9 and body support 2. The expansion of the body support 2 also pivots the arm 5 about the point of connection of the arms to the body support. The movement of the arm 5 causes the head rest 3 to slide along the upper surface 7 towards the upper end 11 of the body rest 2. The movement of the head rest 2 is in the plane of the upper surface 7 of the body support 2 due to the straps 12. This movement exerts a gentle force urging the head of the user in a direction away from his/her torso. Since the air bladders inflate gradually, this force builds up gradually, and so the user experiences a relaxing and gentle stretching and pulling sensation. The user does not experience any sharp or sudden force which would prevent relaxation or cause an injury.

In a similar manner, the shoulder rests 4 gradually move outwardly as their air bladders inflate. As the arms 6 inflate they expand and press against the side walls 8. The expansion of the body support 2 also forces the arms 6 to move. As they continue to expand the shoulder rests 4 at the distal ends of the arms 6 are pulled towards the side walls 8 and away from the centre of the upper surface 7 of the body support 2. This movement is maintained in the plane of the upper surface 7 of the body support 2 by the straps 12, and the movement exerts a gradual and gentle stretching force on the user's shoulders.

The inflation and expansion of the head rest 3 and its arm 5 and the shoulder rests 4 and their arms 6 tend to urge the head rest 3 and shoulder rests 4 away from the upper surface 7 of the body support. The straps 12 ensure that the movement of the head support 3 and the shoulder supports 4 are substantially in the plane of the upper surface 7.

The apparatus 1 further exerts a gradual stretching effect along the length of the user's back. As the air bladder of body support 2 inflates then the upper surface 7 forms the hypotenuse of a triangle. This is slightly longer than the effective length of the uninflated air bladder, and so results in a stretching of the user's back.

When fully inflated the body support 2 is the form of a triangular prism, with the user's head raised up. The body support 2 tapers to the lower end 10 so that there is continuous support for the user's back without any sharp changes in height or pressure.

Once the air bladders have been fully inflated, they are gradually deflated. This may be achieved by drawing air to back through the pump 15 or through a restriction valve in the hand set 17. The deflation of the air cushion 1 also provides a relaxing experience to the user as the air is slowly released from the air bladders 1. The user experiences the sensation of slowly sinking, and the forces exerted on his/her head and shoulders gradually diminish.

The cycle of inflation and deflation of the air bladders 1 may be repeated in a cyclical manner if desired. As well as being used on a flat horizontal surface, the air bladders may be used with the user laying back on the body support 2 from a seated position.

In an alternative method of use, the user may lie on the apparatus 1 with his/her back on the head support 2 and his/her head adjacent to the lower end 11. This provides a different position and form of relaxation in which a relaxing traction sensation is applied to the lower back and sacral joint.

In order to increase the movement of the head rest 3, a pad 16 (see FIG. 6) may be positioned between the arm 5 and the side wall 9 (the pad 16 may be affixed to either). The pad 16 acts to fill space between the arm 5 and the side wall 9, so that as the bladders inflate the expansions of the arm 5 and body support 2 result in an immediate movement of the head rest 3. A pad similar to the pad 16 may also be used to increase the movement of the shoulder supports 4.

The apparatus 1 is preferably large enough to support the head and torso of an adult human user. However, the body support may be large enough to support the entire body of the user. The apparatus would function in the same manner, however the body support 2 would be considerably larger in length. When the user's head is on the head support 3 the user's feet would be adjacent the lower end 11.

An insert 13 (see FIG. 4) can be located inside the body support 2 in order to provide some support for a user even when the body support 2 is completely deflated. The insert 13 may be cuboid or have curved surfaces, and may be made of foam, or similar, or it may be inflatable. The insert 13 is preferably located adjacent the upper end 11 of the body support 2, equidistant the two side walls 8, and at the bottom of the body support 2 (i.e. spaced from the upper surface 7).

A foam insert 13 has the advantage that it will provide support to a user without the user performing any additional action. An inflatable insert 13 requires a valve to allow its inflation and deflation, and the inflatable insert 13 must be inflated before it provides support to a user. However, an inflatable insert 13 has the advantage that it can be deflated and thus allow the air cushion 1 to be completely deflated and folded down to a small size.

The apparatus 1 has previously been described as being inflated by an air pump 15. Alternatively, the body support 2 may self-inflate by the use of an internal frame. This has the advantage that a separate air pump 15 and electrical power source are not required.

As shown in FIGS. 8 to 11, the self inflation is achieved using brackets 19 (see FIG. 11) attached to the perimeter of the body support 2 adjacent the upper surface 7. Corner brackets 20 are also attached to the body support 2 and are spring loaded. A flexible rod, or rods, 21 are threaded through brackets 19 and corner brackets 20. This ensures that the side walls 8 of the body support 2 are in tension.

Inside the body support 2 a Z-shaped frame (see FIG. 10) is formed from top plate 22, middle plate 23 and bottom plate 24. The top plate 22 and the middle plate 23 are rotatably joined by a hinge 25 (see FIGS. 8 and 9) and middle plate 23 and bottom plate 24 are also rotatably joined by a hinge 25 to form a frame which is Z-shaped in cross-section. A resilient insert 32 (see FIGS. 8 and 9) is inserted adjacent to the hinge 25 between the top plate 22 and middle plate 23, and a resilient insert 32 (see FIGS. 8 and 9) is inserted adjacent hinge 25 between middle plate 23 and bottom plate 24. The resilient inserts 32 are formed of a foam-like material having elastic properties. The resilient inserts 32 urge the middle plate 23 to rotate about the hinge 25, and the top plate 22 is urged upwardly away from the middle plate 23 by rotating about the hinge 25. Thus, the bottom plate 24 and top plate 22 are urged into a condition in which they lie substantially parallel and spaced apart.

A restraining cord 29 limits the distance that top plate 22 can move apart from the bottom plate 24. The restraining cord 29 is connected to top plate 22 and bottom plate 24 and passes through an aperture 33 in the middle plate 23. The restraining cord 29 thus limits the maximum height of the Z-frame, and ensures that it returns to a consistent size when there is no load on it. A resilient pad 30 is located on top of the top plate 22. The pad 30 provides a cushioning for the user against the rigid top plate 22.

The bottom plate 24 is secured to the lower part of the body support 2 by means of sleeve 31, as shown in FIG. 10. The sleeve 31 is a substantially square piece of material of slighter larger dimensions than the bottom plate 24. The sleeve 31 is attached to the inside of the body support 2 on three sides, allowing the bottom plate 24 to be inserted between the sleeve 24 and the body support 2. The bottom plate 24 is thus removably held in position.

The movement of the Z-frame is transmitted to the frame on the body support 2 by means of batons 26, rods 27 and brackets 28 (see FIG. 10). The batons 26 are connected to the top plate 22, and two batons 26 connect the top plate 22 to each side wall 8 of the body support 2. Rods 27 are connected to the distal end of batons 26, the rods 27 extending parallel to the side walls 8. The rods 27 are secured to brackets 28. The brackets 28 are secured to rods 21 forming a frame on the side walls 8. The Z-frame is thus connected to the peripheral frame of the body support 2.

The apparatus will initially be deflated, with the z-frame folded substantially flat. To prime the apparatus for use a valve (e.g. in a handset 17) is opened and then air is allowed to enter the body support 2 with the top of plate 22 being urged into a spaced relation from the bottom plate 24 by the resilient inserts 32. This increases in height the body support 2 over the complete width of the body support 2 by way of rods 27 and rods 21. Then, when a user lies on the body support 2, his/her weight will compress the resilient inserts 32 and collapse the Z-frame.

A head rest 3 and shoulder rests 4 are provided at the distal ends of arms in fluid communication with the body support 2 (see FIG. 11). In use the arms are folded from their unfolded positions of FIG. 11 to positions in which their distal ends overlie the top surface of the body rest 2 and provide the head rest and the shoulder rests. There will preferably be provided restrictions to impede air flow into the arms. The arm 5 which provides head support 3 is shown in FIG. 9, in which a restriction valve 43 can be seen in side wall 11. All fluid communication between the arm 5 and body support 2 is through the restriction valve 43. The valve 43 is selected to allow a limited rate of air flow into the arm 5.

A restriction of air flow to the arms with the shoulder rests 4 is preferably also provided by suitable restriction valves. All fluid communication between the arms 6 and body support 2 is preferably through the restriction valves, which allow a limited rate of air flow into the arms 6.

When a user reclines on the apparatus then air in the expanded body rest 2 is compressed by the weight of the user and the compressed air flow through the restriction valves into the arms 5, 6 which then inflate. The inflation of the arms causes the head rest 3 and the shoulder rests 4 to slide over the upper surface 7 of body support 2 to apply traction to the neck and shoulders of the user. During this period the valve in handset 17 will be closed to prevent flow of air out of the apparatus to atmosphere.

After the application of traction then the handset 17 is operated to allow air to flow out of the apparatus and the compression of the Z-frame under the weight of the user. The rate of deflation of the body support 2 can be controlled by limiting the air flow through the valve in handset 17. This allows the user to control the rate of flow of air. The handset has a variable aperture which can be varied in size by the user to alter the rate of flow of air.

Both embodiments of apparatus described above have shoulder rests 4 which move outwardly as the air cushion 1 inflates. However, there are other means by which a gradual outward movement of a part of the apparatus 1 can be achieved. In another embodiment, shown in FIGS. 12 and 13, there are no shoulder rests 4 and instead the body support 2 is provided with opposed inner walls 18. The inner walls 18 define a slit in the centre of the body support 2. The opposed inner walls 18 are located centrally between the side walls 8 and extend over approximately half of the length of the body support 2, centrally located between the lower end 10 and the upper end 11. As shown in FIG. 13, the inner side walls 18 are greater in length than the side walls 8 when the air bladders are inflated.

As the body support 2 begins to inflate the opposed inner walls 18 are pressed together by the air pressure inside the body support 2. As the air pressure continues to increase the excess length of the inner side walls 18 (as compared with the side walls 8) is gradually converted into forming parts of the walls which stand proud of the surrounding upper surface 7 and lower surface of the body support 2. The width of the body support 2 thus increases from the centre, i.e. such that the material of the upper surface 7 expands outwardly from the centre in the central region of the body support 2. This has the effect of gradually exerting an outward force on the user's shoulders similar to that achieved by the shoulder supports 4. On deflation, the body support 2 contracts and the length of the inner side walls 18 is reduced. This provides an inward force in the plane of the upper surface 7 towards the centre of the body support 2 on the user's shoulders.

As shown in FIG. 12, the head rest 3 may be provided with tabs 36 and the body support 2 may be provided with tabs 37. The tabs 36 and 37 are located symmetrically on the air cushion and allow the user to manually judge if the body support 2 and head support 3 are lying straight. The head rest 3 will be as described in the previous embodiments.

As shown in FIGS. 12 and 13, the apparatus 1 may be provided with arm supports 39. The arm supports 39 are located on the two side walls 8 of the body support 2, and extend outwardly from the body support 2. The arm supports 39 provide support for a user's arms. The arm supports 39 are preferably inflatable, and are in fluid connection with the body support 2 by means of arm valves 40. The arm valves 40 may allow free passage of air into the arms or may restrict the flow of air into the arms. Alternatively, the arm valves 40 may be closed so that the arm supports 39 are not inflated. The arm supports 39 can be folded behind the body support 2.

In each embodiment the body support 2 may be provided with a burst valve which allows air to vent out of the body support 2 if it is placed under great pressure. The valve thus prevents the air bladders from bursting if it is subjected to a large pressure. Such a valve may also be opened to allow air to rapidly vent into or from the air bladders.

The body support 2, head rest 3, shoulder rests 4 and, if used, the arm supports 39 are preferably covered with a cover. The cover protects against damage and wear. The cover would be removable and would provide an attractive appearance.

The body support 2, head rest 3, shoulder rests 4, and arm supports 39 are preferably manufactured from PVC, rubberised cotton or similar materials. These materials are lightweight, flexible and can form an air-tight seal. Any part of the body support 2, head rest 3, shoulder rests 4 or arm supports 39 may be formed of a foam-like material to provide padding and structure to the apparatus.

The cover may be formed of a material which is comfortable and pleasant for a user to touch, such as cotton, micropile, flock or velour.

Above, the head rest 3 has been described as an air bladder in fluid connection with the arm 5. However, it is also possible to form the head rest independently from the arm 5.

The head rest 3 may be made of a material such as foam to provide support for the user's head. The head support 3 will still move relative to the body support 2 when the arm is inflated. Furthermore, the arm 5 may also not be in fluid communication with the body support 2, but could be separately inflatable.

The shoulder rests 4 have been described as part of arms 6. However, it is also possible to form the shoulder rests 4 such that they are independent of the arms 6. The shoulder rests 4 may not be inflatable, and instead be made of a material such as foam to provide support for the user's shoulders. The shoulder rests 4 would still move relative to the body support 2 when the arms 6 are inflated. Furthermore, the arms 6 may also not be in fluid connection with the body support 2, but could be separately inflatable

1. Apparatus for applying traction to a human body comprising:
a first body support for supporting a first part of the human body, the first body support having an upper surface engageable by the first part of the human body;
a second body support for supporting a second part of the human body located on top of the upper surface of the first body support and slidable along the upper surface; and
means for causing the second body support to slide along the upper surface of the first body support; wherein
sliding of the second body support along the upper surface of the first body support acts to move the second part of the human body away from the first part of the human body and thereby applies traction to the human body;
wherein the second body support comprises an inflatable bladder and the means for applying a force on the second body support comprises inflation means for inflating the inflatable bladder of the second body support, inflation of the bladder of the second body support giving rise to sliding motion of the second body support along the upper surface of the first body support.

2. Apparatus as claimed in claim 1 wherein the first body support also comprises an inflatable bladder which is in fluid connection with the inflatable bladder of the second body support, whereby gas can flow from the bladder of the first body support to the bladder of the second body support.

3. Apparatus as claimed in claim 2 wherein restriction means restricts flow of gas from the bladder of the first body support to the bladder of the second body support.

4. Apparatus as claimed in claim 3 wherein the bladder of the first body support can be fully or substantially inflated without inflation of the bladder of the second body support so that when the upper surface of the first body support is subsequently engaged by the first body part then the bladder of the first body support under the application of body weight act as the inflation means by forcing gas therein to flow to and inflate the bladder of the second body support.

5. Apparatus as claimed in claim 4 comprising resilient means associated with the bladder of the first body support which can be used to inflate the bladder thereof and which can be subsequently compressed to facilitate storage of the apparatus.

6. Apparatus as claimed in claim 3 comprising pump means for pumping gas into the bladder of the first body support to inflate the bladder of the first body support and also to pass via the bladder of the first body support to inflate the bladder of the second body support, the restriction means ensuring that the bladder of the first body support is inflated in preference to the bladder of the second body support.

7. Apparatus as claimed in claim 6 wherein the pump means is an air pump.

8. Apparatus as claimed in claim 6 wherein the pump means can both inflate and deflate the bladders.

9. Apparatus as claimed in claim 8 wherein the pump means operates to inflate and deflate the bladders in a cyclical manner.

10. Apparatus as claimed in claim 6 wherein the bladder of the first body support is provided with a slit therethrough defined by two opposed walls of the bladder which push against each other on inflation of the bladder to cause parts of the upper surface adjacent the slit to move to apply traction on the first body part when the first body part lies across the slit.

11. Apparatus as claimed in claim 10 wherein the opposed walls extend to have parts which stand proud of the surrounding parts of the upper and lower surfaces of the first body part.

12. Apparatus as claimed in claim 2 wherein the second body support comprises an arm connected at a first end to the first body support and having a second distal end which provides a surface engageable by the second part, the arm being folded around a side wall of the first body support so that the second distal end overlies the upper surface of the first body part, whereby inflation of the bladder of the second body support causes the distal end of the arm to slide along the upper surface of the first body support.

13. Apparatus as claimed in claim 12 wherein: the bladder of the second body support forms all or the majority of the arm; the distal end of the arm is secured by ties to the upper surface of the first body support; and the arm attempts to straighten from the folded position thereof when inflated which results in the sliding of the distal end of the arm along the upper surface of the first body support.

14. Apparatus as claimed in claim 2 having valve means for allowing escape of gas from the bladders, the valve means being controllable to allow a controlled rate of deflation of the bladders.

15. Apparatus as claimed in claim 2 wherein the second body support is a head rest and the first body support is an upper body rest.

16. Apparatus as claimed in claim 2 wherein the second body support is a shoulder rest and the first body support is an upper back rest.

17. Apparatus as claimed in claim 2 wherein the first body support when inflated is wedge-shaped and the second body support overlies the upper surface of the first body support at a thick end of the wedge.

18. Apparatus for applying traction to a human body comprising:
a body support for supporting an upper back of a human user, the first body support having an upper surface engageable by the upper back of the human user;
a head rest located on top of the upper surface of the body support and slidable along the upper surface;
a pair of shoulder rests each located on top of the upper surface of the body support and each slidable along the upper surface;
means for causing the head rest to slide along the upper surface of the first body support to apply traction to a neck of the user; and
means for causing the shoulder rests to slide along the upper surface of the first body support away from each other to apply traction across shoulders of the user;
wherein the head rest and the shoulder rests each comprise an inflatable bladder and the means for causing the head rest and the shoulder rests to slide across the upper surface of the first body support comprises inflation means for inflating the inflatable bladders, inflation of the bladders giving rise to sliding motion of the head rest and the shoulder rests along the upper surface of the first body support.

19. Apparatus as claimed in claim 18 wherein the first body support also comprises an inflatable bladder which is in fluid connection with the inflatable bladders of the head rest and the shoulder rests, whereby gas can flow from the bladder of the first body support to the bladders of the head rest and the shoulder rests.

20. Apparatus as claimed in claim 19 wherein restriction means restricts flow of gas from the bladder of the first body support to the bladders of the head rest and the shoulder rests.

21. Apparatus as claimed in claim 20 comprising pump means for pumping gas into the bladder of the first body support to inflate the bladder of the first body support and also to pass via the bladder of the first body support to inflate the bladders of the head rest and the shoulder rests, the restriction means ensuring that the bladder of the first body support is inflated in preference to the bladders of the head rest and the shoulder rests.

22. Apparatus as claimed in claim 21 wherein the pump means is an air pump.

23. Apparatus as claimed in claim 22 wherein the pump means can both inflate and deflate the bladders.

24. Apparatus as claimed in claim 23 wherein the pump means operates to inflate and deflate the bladders in a cyclical manner.

25. Apparatus as claimed in claim 19 wherein the head rest comprises an arm connected at a first end to the first body support and having a second distal end which provides a surface engageable by the head of the user, the arm being folded around a side wall of the first body support so that the second distal end overlies the upper surface of the first body part, whereby inflation of the bladder of the head rest causes the distal end of the arm to slide along the upper surface of the first body support.

26. Apparatus as claimed in claim 19 wherein each shoulder rest comprises an arm connected at a first end to the first body support and having a second distal end which provides a surface engageable by a shoulder of the user, each arm being folded around a side wall of the first body support so that the second distal end of the arm overlies the upper surface of the first body part, whereby inflation of the bladders of the shoulder rests causes the distal ends of the arms to slide along the upper surface of the first body support.

27. Apparatus as claimed in claim 26 wherein: the bladders of the head rest and the shoulder rests form all or the majority of the arms; the distal end of each arm is secured by ties to the upper surface of the first body support; and each arm attempts to straighten from the folded position thereof when inflated which results in the sliding of the distal end of the arm along the upper surface of the first body support.

28. Apparatus as claimed in claim 19 having valve means for allowing escape of gas from the bladders, the valve means being controllable to allow a controlled rate of deflation of the bladders.

29. Apparatus as claimed in claim 19 wherein the first body support when inflated is wedge-shaped and the head rest overlies the upper surface of the first body support at a thick end of the wedge.

30. A method of using the apparatus claimed in claim 1 in which:
a user lies back on the apparatus with his/her upper back in contact with the first body support and with his/her head in contact with the second body support; and
the second body support is slid across the upper surface of the first body support to apply traction to the user's neck.

31. A method of using the apparatus claimed in claim 18 in which:
a user lies back on the apparatus with his/her upper back in contact with the first body support, with his/her shoulders in contact with the shoulder rests and with his/her head in contact with the head rest; and
the head rest and the shoulder rests are all slid across the upper surface of the first body support to apply traction to the user's neck and across the user's shoulders.
